(19) United States
(12) Patent Application Publication
(10) Pub. No.: US 2015/0368394 A1
(43) Pub. Date: Dec. 24, 2015

(54) CATALYSTS AND METHODS FOR POLYESTER PRODUCTION

(71) Applicant: NOVOMER, INC., Ithaca, NY (US)

(72) Inventor: Scott D. Allen, Ithaca, NY (US)

(21) Appl. No.: 14/410,763

(22) PCT Filed: Jun. 27, 2013
(86) PCT No.: PCT/US13/48238

§ 371 Date: Dec. 23, 2014

Related U.S. Application Data
(60) Provisional application No. 61/664,873, filed on Jun. 27, 2012.

(51) Int. Cl. C08G 63/82

(52) U.S. Cl. CPC C08G 63/826

(57) ABSTRACT

Disclosed are polymerization systems and methods for the formation of polyesters from epoxides and carbon monoxide. The inventive polymerization systems feature the combination of metal carbonyl compounds and polymerization initiators and are characterized in that the molar ratios of metal carbonyl compound, polymerization initiators and provided epoxides are present in certain ratios.

### CROSS REFERENCE TO RELATED APPLICATIONS

The present application claims priority to U.S. provisional application Ser. No. 61/664,873 filed Jun. 27, 2012, the entire content of which is hereby incorporated herein by reference.

### FIELD OF THE INVENTION

The present invention pertains to the field of catalytic carbonylation of epoxides. More particularly, the invention pertains to catalysts and related methods to carbonylate epoxides to provide polyesters such as polypropiolactone (PPL), and poly 3-hydroxy-butyrate (PHB).

### BACKGROUND

Catalytic carbonylation of epoxides has been shown to be useful for the synthesis of commodity chemicals. Several product classes have been targeted by such carbonylation reactions. Hydroformylation of ethylene oxide to provide 3-hydroxy-propanal has been practiced commercially by Shell to make 1,3 propanediol. A related process developed by Samsung and Davy Process Technology Ltd attempts methoxy carbonylation of ethylene oxide to form methyl-3-hydroxy propionate which may also be converted to 1,3 propanediol. Cornell University and Novomer, Inc. have developed processes for the carbonylation of ethylene oxide to provide propiolactone and/or succinic anhydride which may be converted to useful C₃ and C₄ chemicals such as acrylic acid, tetrahydrofuran, 1,4 butanediol and succinic acid.

Attempts have previously been made to produce polymers by copolymerization of epoxides and carbon monoxide using processes closely related to these carbonylation reactions. In fact, there has been debate as to whether formation of polyesters using such methods are the result of polymerization of beta lactone products, or whether the alternating enchainment of epoxide and CO is directly promoted by the catalysts. Attempts to improve systems for the copolymerization of epoxides and CO have been largely focused on producing poly-3-hydroxybutyrate (PHB) from propylene oxide. Attempts to date to optimize this copolymerization have provided disappointing results, with the reactions requiring high catalyst loadings, aggressive temperatures and pressures, and yet requiring relatively long reaction times to produce modest yields of polymer.

There remains a need for efficient catalysts and systems for the copolymerization of epoxides and carbon monoxide to provide polyester in high yield.

### SUMMARY OF THE INVENTION

The present invention provides polymerization systems and methods for the alternating copolymerization of epoxides and carbon monoxide to provide polyesters.

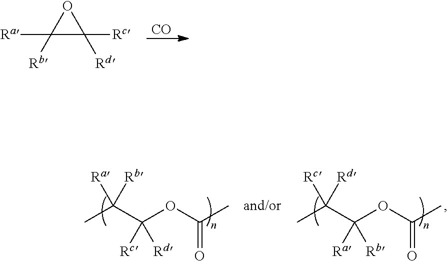

R^{a′} is hydrogen or an optionally substituted group selected from the group consisting of C₁₋₃₀ aliphatic; C₁₋₃₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-3 heteroatoms independently selected from the group consisting of nitrogen, oxygen, and sulfur;
each of R^{b′}, R^{c′}, and R^{d′} is independently hydrogen or an optionally substituted group selected from the group consisting of C₁₋₁₂ aliphatic; C₁₋₁₂ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-3 heteroatoms independently selected from the group consisting of nitrogen, oxygen, and sulfur;
wherein any of (R^{b′} and R^{c′}), (R^{c′} and R^{d′}), and (R^{a′} and R^{b′}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl.

In some aspects, the present invention encompasses the recognition that the presence of reactive nucleophiles in carefully chosen amounts can dramatically increase the rate and yield of such copolymerizations.

The key steps for ring-expansive carbonylation of epoxides with a nucleophilic metal carbonyl (denoted [M(CO)_{y}]) to provide beta lactone, and the related alkoxy carbonylation reaction to provide hydroxyalkanoates have been well studied and are generally understood. Prevailing understanding has it that the metal atom of the metal carbonyl acts as a nucleophile which ring opens the epoxide (typically with the assistance of a Lewis acid coordinated to the oxygen atom of the epoxide) to provide a new metal-carbon bond, a CO molecule then inserts into the newly formed metal carbon bond to give an intermediate acyl metal carbonyl compound. Depending on the reaction conditions, the acyl metal carbonyl compound then undergoes further reaction such as intramolecular ring closing to give the beta lactone, or hydrolysis or alcoholysis to provide useful products, as shown in Scheme 1, where the moiety -Q in intermediate S-1 represents a Lewis acid, a negative charge, or a proton depending on the reaction conditions employed to form S-1.

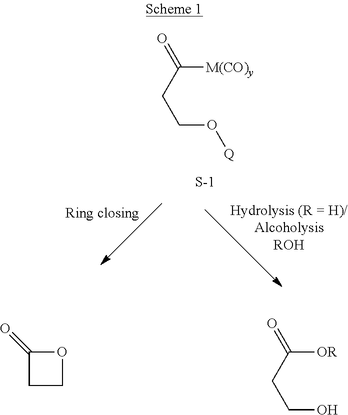

In previously reported systems for the carbonylation of epoxides, alcohols (and other protic species such as water or carboxylic acids) are either rigorously excluded if the desired product is beta lactone (e.g. U.S. Pat. No. 6,852,865), or provided in large excess if the hydroxy alkanoate is desired (e.g. US 2007/0191629). In contrast, some aspects of the present invention encompass novel carbonylation systems and related methods characterized in that a protic species (hereinafter referred to as a polymerization initiator or P_{In}) is present in a molar excess relative to the metal carbonyl, but in a substoichiometric amount relative to epoxide.

Without being bound by theory, or thereby limiting the scope of the present invention which is defined by the claims appended hereto, it is believed that the presence of such polymerization initiators can alleviate a bottleneck in the reaction sequence responsible for conversion of the epoxide and CO to polyester. In a polymerization of the present invention, the initial stages of the reaction are analogous to the hydrolysis route shown on the right half of Scheme 1 (namely, the provided P_{In} will attack the acyl metal carbonyl to yield the corresponding ester). However, because there is a limiting amount of P_{In} present relative to epoxide, this mode of reaction will cease when the provided amount of P_{In} is consumed. From that point, the hydroxyl groups of hydroxy alkanoates produced during the early stage of the reaction will proceed to react with the acyl metal carbonyl intermediate and the formation of oligomers and/or polymers will result. This system leads to more facile polymerization than reactions in which there is no P_{In} present, since there is a higher concentration of polymer chain ends present in the mixture to intercept the acyl metal carbonyl intermediate.

Therefore in certain embodiments, the present invention encompasses a polymerization system for the alternating copolymerization of epoxides and carbon monoxide, the system comprising a metal carbonyl compound and a polymerization initiator (P_{In}) wherein the molar ratio of polymerization initiator to metal carbonyl (MC) is greater than 1:1 and the molar ratio of epoxide to polymerization initiator is greater than 1:1; or stated another way, polymerization systems are characterized in that, on a molar basis MC<P_{In}<Epoxide.

In certain embodiments, polymerization systems of the present invention are characterized in that the molar ratio of P_{In} to metal carbonyl in the system is greater than 2:1. In certain embodiments, polymerization systems of the present invention are characterized in that the molar ratio of P_{In} to metal carbonyl in the system is greater than 5:1, greater than 10:1, greater than 50:1, or greater than 100:1. In certain embodiments, the molar ratio of P_{In} to metal carbonyl in the system is between about 10:1 and about 100:1. In certain embodiments, the molar ratio of P_{In} to metal carbonyl in the system is between about 50:1 and about 500:1. In certain embodiments, the molar ratio of P_{In} to metal carbonyl in the system is between about 200:1 and about 1,000:1. In certain embodiments, the molar ratio of P_{In} to metal carbonyl in the system is between about 200:1 and about 500:1. In certain embodiments, the molar ratio of P_{In} to metal carbonyl in the system is between about 500:1 and about 1,000:1. In certain embodiments, the molar ratio of P_{In} to metal carbonyl in the system is between about 1,000:1 and about 5,000:1.

In certain embodiments, polymerization systems of the present invention are characterized in that the molar ratio of epoxide to P_{In} in the system is greater than 2:1. In certain embodiments, polymerization systems of the present invention are characterized in that the molar ratio of epoxide to P_{In} in the system is greater than 5:1. In certain embodiments, the molar ratio of epoxide to P_{In} in the system is greater than 10:1, greater than 20:1, greater than 50:1, or greater than 100:1. In certain embodiments, the molar ratio of epoxide to P_{In} in the system is between 10:1 and 100:1. In certain embodiments, the molar ratio of epoxide to P_{In} in the system is between 20:1 and 50:1. In certain embodiments, the molar ratio of epoxide to P_{In} in the system is between 20:1 and 200:1. In certain embodiments, the molar ratio of epoxide to P_{In} in the system is between 50:1 and 200:1. In certain embodiments, the molar ratio of epoxide to P_{In} in the system is between 100:1 and 500:1. In certain embodiments, the molar ratio of epoxide to P_{In} in the system is between 200:1 and 1000:1. In certain embodiments, the molar ratio of epoxide to P_{In} in the system is between 500:1 and 2,000:1.

In certain embodiments, polymerization systems of the present invention are characterized in that the system includes a molar ratio of P_{In} to metal carbonyl that is greater than 10:1 in combination with a molar ratio of epoxide to P_{In} that is greater than 5:1. In certain embodiments, the molar ratio of P_{In} to metal carbonyl is greater than 10:1 and the molar ratio of epoxide to P_{In}, is greater than 10:1. In certain embodiments, the molar ratio of P_{In} to metal carbonyl is greater than 10:1 and the molar ratio of epoxide to P_{In} is greater than 20:1. In certain embodiments, the molar ratio of P_{In} to metal carbonyl is greater than 20:1 and the molar ratio of epoxide to P_{In} is greater than 10:1. In certain embodiments, the molar ratio of P_{In} to metal carbonyl is greater than 50:1 and the molar ratio of epoxide to P_{In} is greater than 10:1. In certain embodiments, the molar ratio of P_{In} to metal carbonyl is greater than 100:1 and the molar ratio of epoxide to P_{In} is greater than 5:1.

In certain embodiments, polymerization systems of the present invention comprise one or more additional components. In certain embodiments, polymerization systems of the present invention comprise Lewis acids. Suitable Lewis acids include, but are not limited to: transition metal complexes, metal salts, boron compounds, and the like. In certain embodiments, polymerization systems of the present invention comprise transesterification catalysts. Suitable transesterification catalysts include amine compounds such as DMAP, DBU, MeTBD, DABCO, imidazole derivatives and tin compounds such as dibutyl tin alkaonates, and the like.

### DEFINITIONS

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds of the present invention can comprise one or more asymmetric centers, and thus can exist in various stereoisomeric forms, e.g., enantiomers and/or diastereomers. Thus, inventive compounds and compositions thereof may be in the form of an individual enantiomer, diastereomer or geometric isomer, or may be in the form of a mixture of stereoisomers. In certain embodiments, the compounds of the invention are enantiopure compounds. In certain other embodiments, mixtures of enantiomers or diastereomers are provided.

Furthermore, certain compounds, as described herein may have one or more double bonds that can exist as either a Z or E isomer, unless otherwise indicated. The invention additionally encompasses the compounds as individual isomers substantially free of other isomers and alternatively, as mixtures of various isomers, e.g., racemic mixtures of enantiomers. In addition to the above-mentioned compounds per se, this invention also encompasses compositions comprising one or more compounds.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a compound may, in some embodiments, be provided substantially free of one or more corresponding stereoisomers, and may also be referred to as “stereochemically enriched.”

Where a particular enantiomer is preferred, it may, in some embodiments be provided substantially free of the opposite enantiomer, and may also be referred to as “optically enriched.” “Optically enriched,” as used herein, means that the compound is made up of a significantly greater proportion of one enantiomer. In certain embodiments the compound is made up of at least about 90% by weight of an enantiomer. In some embodiments the compound is made up of at least about 95%, 97%, 98%, 99%, 99.5%, 99.7%, 99.8%, or 99.9% by weight of an enantiomer. In some embodiments the enantiomeric excess of provided compounds is at least about 90%, 95%, 97%, 98%, 99%, 99.5%, 99.7%, 99.8%, or 99.9%. In some embodiments, enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, Ind. 1972).

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-30 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in yet other embodiments aliphatic groups contain 1-3 carbon atoms, and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic,” as used herein, refers to aliphatic groups wherein one or more carbon atoms are independently replaced by one or more atoms selected from the group consisting of oxygen, sulfur, nitrogen, phosphorus, or boron. In certain embodiments, one or two carbon atoms are independently replaced by one or more of oxygen, sulfur, nitrogen, or phosphorus. Heteroaliphatic groups may be substituted or unsubstituted, branched or unbranched, cyclic or acyclic, and include “heterocycle,” “hetercyclyl,” “heterocycloaliphatic,” or “heterocyclic” groups.

The term “epoxide”, as used herein, refers to a substituted or unsubstituted oxirane. Substituted oxiranes include monosubstituted oxiranes, disubstituted oxiranes, trisubstituted oxiranes, and tetrasubstituted oxiranes. Such epoxides may be further optionally substituted as defined herein. In certain embodiments, epoxides comprise a single oxirane moiety. In certain embodiments, epoxides comprise two or more oxirane moieties.

The term “glycidyl”, as used herein, refers to an oxirane substituted with a hydroxyl methyl group or a derivative thereof. The term glycidyl as used herein is meant to include moieties having additional substitution on one or more of the carbon atoms of the oxirane ring or on the methylene group of the hydroxymethyl moiety, examples of such substitution may include, but are not limited to: alkyl groups, halogen atoms, aryl groups etc. The terms glycidyl ester, glycidyl acrylate, glydidyl ether etc. denote substitution at the oxygen atom of the above-mentioned hydroxymethyl group, i.e. that oxygen atom is bonded to an acyl group, an acrylate group, or an alkyl group respectively.

The term “acrylate” or “acrylates” as used herein refer to any acyl group having a vinyl group adjacent to the acyl carbonyl. The terms encompass mono-, di- and trisubstituted vinyl groups. Examples of acrylates include, but are not limited to: acrylate, methacrylate, ethacrylate, cinnamate (3-phenylacrylate), crotonate, tiglate, and senecioate.

The term “polymer”, as used herein, refers to a molecule of high relative molecular mass, the structure of which comprises the multiple repetition of units derived, actually or conceptually, from molecules of low relative molecular mass. In certain embodiments, a polymer is comprised of only one monomer species (e.g., polyethylene oxide). In certain embodiments, a polymer of the present invention is a copolymer, terpolymer, heteropolymer, block copolymer, or tapered heteropolymer of one or more epoxides.

The term “unsaturated”, as used herein, means that a moiety has one or more double or triple bonds.

The terms “cycloaliphatic”, “carbocycle”, or “carbocyclic”, used alone or as part of a larger moiety, refer to a saturated or partially unsaturated cyclic aliphatic monocyclic, bicyclic, or polycyclic ring systems, as described herein, having from 3 to 12 members, wherein the aliphatic ring system is optionally substituted as defined above and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, and cyclooctadienyl. In some embodiments, the cycloalkyl has 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. In some embodiments, a carbocyclic groups is bicyclic. In some embodiments, a carbocyclic group is tricyclic. In some embodiments, a carbocyclic group is polycyclic.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “alkynyl,” as used herein, refers to a monovalent group derived from a straight- or branched-chain aliphatic moiety having at least one carbon-carbon triple bond by the removal of a single hydrogen atom. Unless otherwise specified, alkynyl groups contain 2-12 carbon atoms. In certain embodiments, alkynyl groups contain 2-8 carbon atoms. In certain embodiments, alkynyl groups contain 2-6 carbon atoms. In some embodiments, alkynyl groups contain 2-5 carbon atoms, in some embodiments, alkynyl groups contain 2-4 carbon atoms, in yet other embodiments alkynyl groups contain 2-3 carbon atoms, and in yet other embodiments alkynyl groups contain 2 carbon atoms. Representative alkynyl groups include, but are not limited to, ethynyl, 2-propynyl (propargyl), 1-propynyl, and the like.

The term “carbocycle” and “carbocyclic ring” as used herein, refers to monocyclic and polycyclic moieties wherein the rings contain only carbon atoms. Unless otherwise specified, carbocycles may be saturated, partially unsaturated or aromatic, and contain 3 to 20 carbon atoms. Representative carbocyles include cyclopropane, cyclobutane, cyclopentane, cyclohexane, bicyclo[2,2,1]heptane, norbornene, phenyl, cyclohexene, naphthalene, spiro[4.5]decane,

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In certain embodiments of the present invention, “aryl” refers to an aromatic ring system which includes, but is not limited to, phenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenanthridinyl, or tetrahydronaphthyl, and the like.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, 9 or 10 ring atoms; having 6, 10, or 14 π electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono- or bicyclic. The term “heteroaryl” may be used interchangeably with the terms “heteroaryl ring”, “heteroaryl group”, or “heteroaromatic”, any of which terms include rings that are optionally substituted. The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7- to 14-membered bicyclic heterocyclic moiety that is either saturated or partially unsaturated, and having, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl), or ⁺NR (as in N-substituted pyrrolidinyl).

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothienyl, pyrrolidinyl, pyrrolidonyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The terms “heterocycle”, “heterocyclyl”, “heterocyclyl ring”, “heterocyclic group”, “heterocyclic moiety”, and “heterocyclic radical”, are used interchangeably herein, and also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl, where the radical or point of attachment is on the heterocyclyl ring. A heterocyclyl group may be mono- or bicyclic. The term “heterocyclylalkyl” refers to an alkyl group substituted by a heterocyclyl, wherein the alkyl and heterocyclyl portions independently are optionally substituted.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

In some chemical structures herein, substituents are shown attached to a bond which crosses a bond in a ring of the depicted molecule. This means that one or more of the substituents may be attached to the ring at any available position (usually in place of a hydrogen atom of the parent structure). In cases where an atom of a ring so substituted has two substitutable positions, two groups may be present on the same ring atom. When more than one substituent is present, each is defined independently of the others, and each may have a different structure. In cases where the substituent shown crossing a bond of the ring is —R, this has the same meaning as if the ring were said to be “optionally substituted” as described in the preceding paragraph.

Suitable monovalent substituents on a substitutable carbon atom of an “optionally substituted” group are independently halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)N(R^{∘})₂; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄C(O)NR₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur, or, notwithstanding the definition above, two independent occurrences of R^{∘}, taken together with their intervening atom(s), form a 3-12-membered saturated, partially unsaturated, or aryl mono- or polycyclic ring having 0-4 heteroatoms independently selected from nitrogen, oxygen, and sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{•}, -(haloR^{•}), —(CH₂)₀₋₂OH, —(CH₂)₀₋₂OR^{°}, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₄C(O)N(R^{•})₂; —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR^{•}, or —SSR^{•} wherein each R^{•} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, and sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, and sulfur.

Suitable substituents on the aliphatic group of R* include halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, and sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, and sulfur.

Suitable substituents on the aliphatic group of R^{†} are independently halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur.

As used herein, the term “catalyst” refers to a substance the presence of which increases the rate of a chemical reaction, while not being consumed or undergoing a permanent chemical change itself.

“Tetradentate” refers to ligands having four sites capable of coordinating to a single metal center.

As used herein, the term “about” preceding one or more numerical values means the numerical value±5%.

### DETAILED DESCRIPTION OF CERTAIN EMBODIMENTS

The present invention provides polymerization systems and methods for the alternating copolymerization epoxides and carbon monoxide.

### I. Polymerization Systems

In one aspect, the present invention encompasses polymerization systems for the copolymerization of epoxides and carbon monoxide. The inventive polymerization systems comprise one or more epoxides, at least one metal carbonyl compound and a Polymerization Initiator (P₁) and are characterized in that there is a molar excess of P_{In} relative to metal carbonyl, and that there is a molar excess of epoxide relative to P_{In}.

I(a) Metal Carbonyl Compounds

As noted above, polymerization systems of the present invention comprise at least one metal carbonyl compound. Typically, a single metal carbonyl compound is provided, but in certain embodiments mixtures of two or more metal carbonyl compounds are provided. (Thus, when a provided metal carbonyl compound “comprises”, e.g., a neutral metal carbonyl compound, it is understood that the provided metal carbonyl compound can be a single neutral metal carbonyl compound, or a neutral metal carbonyl compound in combination with one or more metal carbonyl compounds.) Preferably, the provided metal carbonyl compound is capable of ring-opening an epoxide and facilitating the insertion of CO into the resulting metal carbon bond. Metal carbonyl compounds with this reactivity are well known in the art and are used for laboratory experimentation as well as in industrial processes such as hydroformylation.

In certain embodiments, a provided metal carbonyl compound comprises an anionic metal carbonyl moiety. In other embodiments, a provided metal carbonyl compound comprises a neutral metal carbonyl compound. In certain embodiments, a provided metal carbonyl compound comprises a metal carbonyl hydride or a hydrido metal carbonyl compound. In some embodiments, a provided metal carbonyl compound acts as a pre-catalyst which reacts in situ with one or more reaction components to provide an active species different from the compound initially provided. Such pre-catalysts are specifically encompassed by the present invention as it is recognized that the active species in a given reaction may not be known with certainty; thus the identification of such a reactive species in situ does not itself depart from the spirit or teachings of the present invention.

In certain embodiments, the metal carbonyl compound comprises an anionic metal carbonyl species. In certain embodiments, such anionic metal carbonyl species have the general formula [Q_{d}M′ₑ(CO)_{w}]^{y-}, where Q is any ligand and need not be present, M′ is a metal atom, d is an integer between 0 and 8 inclusive, e is an integer between 1 and 6 inclusive, w is a number such as to provide the stable anionic metal carbonyl complex, and y is the charge of the anionic metal carbonyl species. In certain embodiments, the anionic metal carbonyl has the general formula [QM′(CO)_{w}]^{y-}, where Q is any ligand and need not be present, M′ is a metal atom, w is a number such as to provide the stable anionic metal carbonyl, and y is the charge of the anionic metal carbonyl.

In certain embodiments, the anionic metal carbonyl species include monoanionic carbonyl complexes of metals from groups 5, 7 or 9 of the periodic table or dianionic carbonyl complexes of metals from groups 4 or 8 of the periodic table. In some embodiments, the anionic metal carbonyl compound contains cobalt or manganese. In some embodiments, the anionic metal carbonyl compound contains rhodium. Suitable anionic metal carbonyl compounds include, but are not limited to: [Co(CO)₄]⁻, [Ti(CO)₆]²⁻[V(CO)₆]⁻[Rh(CO)₄]⁻, [Fe(CO)₄]²⁻[Ru(CO)₄]²⁻, [Os(CO)₄]²⁻[Cr₂(CO)₁₀]²⁻[Fe₂(CO)₈]²⁻[Tc(CO)₅]⁻[Re(CO)₅]⁻ and [Mn(CO)₅]⁻. In certain embodiments, the anionic metal carbonyl comprises [Co(CO)₄]⁻. In some embodiments, a mixture of two or more anionic metal carbonyl complexes may be present in the polymerization system.

The term “such as to provide a stable anionic metal carbonyl” for [Q_{d}M′ₑ(CO)_{w}]^{y-} is used herein to mean that [Q_{d}M′ₑ(CO)_{w}]^{y-} is a species characterizable by analytical means, e.g., NMR, IR, X-ray crystallography, Raman spectroscopy and/or electron spin resonance (EPR) and isolable in catalyst form in the presence of a suitable cation or a species formed in situ. It is to be understood that metals which can form stable metal carbonyl complexes have known coordinative capacities and propensities to form polynuclear complexes which, together with the number and character of optional ligands Q that may be present and the charge on the complex will determine the number of sites available for CO to coordinate and therefore the value of w. Typically, such compounds conform to the “18-electron rule”. Such knowledge is within the grasp of one having ordinary skill in the arts pertaining to the synthesis and characterization of metal carbonyl compounds.

In embodiments where the provided metal carbonyl compound is an anionic species, one or more cations must also necessarily be present. The present invention places no particular constraints on the identity of such cations. In certain embodiments, the cation associated with an anionic metal carbonyl compound comprises a reaction component of another category described hereinbelow. For example, in certain embodiments, the metal carbonyl anion is associated with a cationic Lewis acid. In other embodiments a cation associated with a provided anionic metal carbonyl compound is a simple metal cation such as those from Groups 1 or 2 of the periodic table (e.g. Na⁺, Li⁺, K⁺, Mg²⁺ and the like). In other embodiments a cation associated with a provided anionic metal carbonyl compound is a bulky non electrophilic cation such as an ‘onium salt’ (e.g. Bu₄N⁺, PPN⁺, Ph₄P⁺Ph₄As⁺, and the like). In other embodiments, a metal carbonyl anion is associated with a protonated nitrogen compound, in some embodiments, such protonated nitrogen compounds are acyl transfer or tranesterification catalysts as described more fully hereinbelow (e.g. a cation may comprise a compound such as MeTBD-H⁺, DMAP-H⁺, DABCO-H⁺, DBU-H⁺ and the like). In certain embodiments, compounds comprising such protonated nitrogen compounds are provided as the reaction product between an acidic hydrido metal carbonyl compound (described more fully below) and a basic nitrogen-containing compound (e.g. a mixture of DBU and HCo(CO)₄).

In certain embodiments, a provided metal carbonyl compound comprises a neutral metal carbonyl. In certain embodiments, such neutral metal carbonyl compounds have the general formula Q_{d}M′ₑ(CO)_{w′}, where Q is any ligand and need not be present, M′ is a metal atom, d is an integer between 0 and 8 inclusive, e is an integer between 1 and 6 inclusive, and w′ is a number such as to provide the stable neutral metal carbonyl complex. In certain embodiments, the neutral metal carbonyl has the general formula QM′(CO)_{w′}. In certain embodiments, the neutral metal carbonyl has the general formula M′(CO)_{w′}. In certain embodiments, the neutral metal carbonyl has the general formula QM′₂(CO)_{w′}. In certain embodiments, the neutral metal carbonyl has the general formula M′₂(CO)_{w′}. Suitable neutral metal carbonyl compounds include, but are not limited to: Ti(CO)₇; V₂(CO)₁₂; Cr(CO)₆; Mo(CO)₆; W(CO)₆Mn₂(CO)₁₀, Tc₂(CO)₁₀, and Re₂(CO)₁₀Fe(CO)₅, Ru(CO)₅ and Os(CO)₅Ru₃(CO)₁₂, and Os₃(CO)₁₂Fe₃(CO)₁₂ and Fe₂(CO)₉Co₄(CO)₁₂, Rh₄(CO)₁₂, Rh₆(CO)₁₆, and Ir₄(CO)₁₂Co₂(CO)₈Ni(CO)₄.

The term “such as to provide a stable neutral metal carbonyl for Q_{d}M′ₑ(CO)_{w′} is used herein to mean that Q_{d}M′ₑ(CO)_{w′} is a species characterizable by analytical means, e.g., NMR, IR, X-ray crystallography, Raman spectroscopy and/or electron spin resonance (EPR) and isolable in pure form or a species formed in situ. It is to be understood that metals which can form stable metal carbonyl complexes have known coordinative capacities and propensities to form polynuclear complexes which, together with the number and character of optional ligands Q that may be present will determine the number of sites available for CO to coordinate and therefore the value of w′. Typically, such compounds conform to stoichiometries conforming to the “18-electron rule”. Such knowledge is within the grasp of one having ordinary skill in the arts pertaining to the synthesis and characterization of metal carbonyl compounds.

In certain embodiments, one or more of the CO ligands of any of the metal carbonyl compounds described above is replaced with a ligand Q. In certain embodiments, Q is a phosphine ligand. In certain embodiments, Q is a triaryl phosphine. In certain embodiments, Q is trialkyl phosphine. In certain embodiments, Q is a phosphite ligand. In certain embodiments, Q is an optionally substituted cyclopentadienyl ligand. In certain embodiments, Q is cp. In certain embodiments, Q is cp*.

In certain embodiments, polymerization systems of the present invention comprise hydrido metal carbonyl compounds. In certain embodiments, such compounds are provided as the hydrido metal carbonyl compound, while in other embodiments, the hydrido metal carbonyl is generated in situ by reaction with hydrogen gas, or with a protic acid using methods known in the art (see for example Chem. Rev., 1972, 72 (3), pp 231-281 DOI: 10.1021/cr60277a003, the entirety of which is incorporated herein by reference).

In certain embodiments, the hydrido metal carbonyl (either as provided or generated in situ) comprises one or more of HCo(CO)₄, HCoQ(CO)₃, HMn(CO)₅, HMn(CO)₄Q, HW(CO)₃Q, HRe(CO)₅, HMo(CO)₃Q, HOs(CO)₂Q, HMo(CO)₂Q₂, HFe(CO₂)Q, HW(CO)₂Q₂, HRuCOQ₂, H₂Fe(CO)₄ or H₂Ru(CO)₄, where each Q is independently as defined above and in the classes and subclasses herein. In certain embodiments, the metal carbonyl hydride (either as provided or generated in situ) comprises HCo(CO)₄. In certain embodiments, the metal carbonyl hydride (either as provided or generated in situ) comprises HCo(CO)₃PR₃, where each R is independently an optionally substituted aryl group, an optionally substituted C₁₋₂₀ aliphatic group, an optionally substituted C₁₋₁₀ alkoxy group, or an optionally substituted phenoxy group. In certain embodiments, the metal carbonyl hydride (either as provided or generated in situ) comprises HCo(CO)₃cp, where cp represents an optionally substituted pentadienyl ligand. In certain embodiments, the metal carbonyl hydride (either as provided or generated in situ) comprises HMn(CO)₅. In certain embodiments, the metal carbonyl hydride (either as provided or generated in situ) comprises H₂Fe(CO)₄.

In certain embodiments, for any of the metal carbonyl compounds described above, M′ comprises a transition metal. In certain embodiments, for any of the metal carbonyl compounds described above, M′ is selected from Groups 5 (Ti) to 10 (Ni) of the periodic table. In certain embodiments, M′ is a Group 9 metal. In certain embodiments, M′ is Co. In certain embodiments, M′ is Rh. In certain embodiments, M′ is Ir. In certain embodiments, M′ is Fe. In certain embodiments, M′ is Mn.

In certain embodiments, one or more ligands Q is present in a provided metal carbonyl compound. In certain embodiments, Q is a phosphine ligand. In certain embodiments, Q is a triaryl phosphine. In certain embodiments, Q is trialkyl phosphine. In certain embodiments, Q is a phosphite ligand. In certain embodiments, Q is an optionally substituted cyclopentadienyl ligand. In certain embodiments, Q is cp. In certain embodiments, Q is cp*.

I(b) Polymerization Initiators

As described above, polymerization systems of the present invention comprise polymerization initiators, denoted P_{In}. Suitable polymerization initiators are characterized in that their presence leads to the formation of additional polymer chains. In general, the presence of polymerization initiators in a reaction will result in an increase in the number of polymer chains formed per unit of catalyst provided. Typically, a single polymerization initiatior is provided, but in certain embodiments mixtures of two or more polymerization initiatiors are provided. (Thus, when a provided polymerization initiatior “comprises”, e.g., an alcohol, it is understood that the provided polymerization initiatior can be a single alcohol, or an alcohol in combination with one or more polymerization initiators.)

Suitable initiators include nucleophiles that are reactive toward acyl metal carbonyl compounds and also compounds that can ring-open an epoxide. In some embodiments, initiators may act by one or both of these modes. Examples of suitable polymerization initiators include, but are not limited to: alcohols, carboxylic acids, amines, halides, sulfonic acids and the like.

In certain embodiments, provided polymerization initiators comprise one or more exchangeable hydrogen atoms. In certain embodiments, such exchangeable hydrogen atoms are attached to an oxygen or nitrogen atom. In certain embodiments, provided polymerization initiators comprise one or more —OH groups. Such —OH groups may be attached to aliphatic carbon atoms (i.e. alcohols), aromatic carbon atoms (i.e. phenols), carbonyl groups (i.e. carboxylic acids), SP2 carbon atoms (i.e. enols), or attached to heteroatoms such as N, P, B, or S, (i.e. hydroxyl amines, phosphoric acids, borates, sulfonic acids and the like). In certain embodiments, provided polymerization initiators comprise anionic forms of any of the above (e.g. alkoxides, carboxylates, enolates and the like)

In certain embodiments, provided polymerization initiators comprise nucleophiles that can ring-open an epoxide. Suitable nucleophiles include, but are not limited to, anions such as halides, cyanide, nitrate, azide, carboxylates, sulfides, sulfonates, and the like.

In certain embodiments, a provided polymerization initiator comprises water. In certain embodiments, provided polymerization initiators comprise alcohols. In certain embodiments, polymerization initiators comprise carboxylic acids.

I(b)-1 Alcohols as Polymerization Initiators

In certain embodiments, a provided polymerization initiator comprises an alcohol (or an alkoxide). In certain embodiments, a provided polymerization initiator comprises an aliphatic alcohol, an aromatic alcohol, or a polymeric alcohol. In certain embodiments, a provided polymerization initiator comprises a polyhydric alcohol such as a diol, a triol, a tetraol, or a higher polyhydric alcohol. In certain embodiments, a provided polymerization initiator comprises a solid-supported alcohol. In certain embodiments, a provided polymerization initiator comprises a mono-acylated glycol. In certain embodiments, a provided polymerization initiator comprises an optionally substituted alkoxylated acrylate.

In certain embodiments, provided polymerization initiators comprise C₁₋₂₀ aliphatic alcohols. In certain embodiments, provided polymerization initiators comprise C₁₋₁₂ aliphatic alcohols. In certain embodiments, provided polymerization initiators comprise C₁₋₈ aliphatic alcohols. In certain embodiments, provided polymerization initiators comprise C₁₋₆ aliphatic alcohols. In certain embodiments, provided polymerization initiators comprise C₁₋₄ aliphatic alcohols. In certain embodiments, a provided polymerization initiator is selected from the group consisting of: methanol, ethanol, 1-propanol, 1-butanol, isobutanol, isopentanol, neopentanol, 2-methyl-1-butanol, 1-pentanol, 1-hexanol, 1-octanol, 2-propanol, 2-butanol, 2-pentanol, 2-hexanol, 2-heptanol, 2-octanol cyclopentanol, cyclohexanol, 4-methylcyclohexanol, 3-methylcyclopentanol, allyl alcohol, methyl 2-butenol, cis-2-butenol, trans-2-butenol, and benzyl alcohol.

In certain embodiments, a provided polymerization initiator comprises an alcohol having a formula:

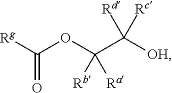

where each of R^{a′}, R^{b′}, R^{c′}, and R^{d′} is as defined above and in the classes and subclasses herein, and
R^{g} is selected from the group consisting of optionally substituted C₁₋₁₂ aliphatic, C₁₋₄ perfluoro aliphatic, optionally substituted alkenyl, and optionally substituted aryl.

In certain embodiments, a provided polymerization initiator comprises an alcohol having a formula:

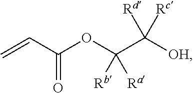

where each of R^{a′}, R^{b′}, R^{c′}, and R^{d′} is as defined above and in the classes and subclasses herein.

In certain embodiments, a provided polymerization initiator comprises an alcohol having a formula:

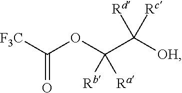

where each of R^{a′}, R^{b′}, R^{c′}, and R^{d′} is as defined above and in the classes and subclasses herein.

In certain embodiments, a provided polymerization initiator comprises an alcohol having a formula:

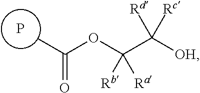

where each of R^{a′}, R^{b′}, R^{c′}, and R^{d′} is as defined above and in the classes and subclasses herein, and
[symbol] comprises a polymeric support.

In certain embodiments, where a polymerization system includes one of the above polymerization initiators, each of R^{a′}, R^{b′}, R^{c′}, and R^{d′} in the polymerization initiator is the same as the corresponding R^{a′}, R^{b′}, R^{c′}, and R^{d′} in the provided epoxide.

In certain embodiments, each of R^{a′}, R^{b′}, R^{c′}, and R^{d′} is independently selected from —H, and optionally substituted C₁₋₃₀ aliphatic where two or more of R^{a′}, R^{b′}, R^{c′}, and R^{d′} can be taken together to form an optionally substituted ring. In certain embodiments, each of R^{a′}, R^{b′}, R^{c′}, and R^{d′} is independently selected from —H, and optionally substituted C₁₋₁₂ aliphatic. In certain embodiments, each of R^{a′}, R^{b′}, R^{c′}, and R^{d′} is independently selected from —H, and optionally substituted C₁₋₆ aliphatic. In certain embodiments, each of R^{a′}, R^{b′}, R^{c′}, and R^{d′} is independently selected from —H, and methyl. In certain embodiments, each of R^{a′}, R^{b′}, R^{c′}, and R^{d′} is —H. In certain embodiments, one of R^{a′}, R^{b′}, R^{c′}, and R^{d′} is —CH₃, and the remaining three are —H.

In certain embodiments, a provided polymerization initiator comprises an alcohol selected from the group consisting of:

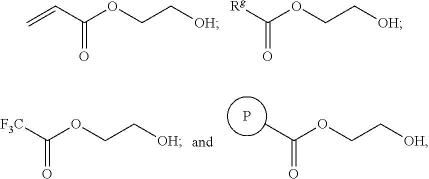

where each of [symbol] and R^{g} is as defined above and in the classes and subclasses herein.

In certain embodiments, a provided polymerization initiator comprises:

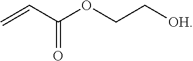

In certain embodiments, a provided polymerization initiator comprises an optionally substituted phenol.

In certain embodiments, a provided polymerization initiator comprises more than one hydroxyl group. In certain embodiments, such initiators comprise diols, triols, tetraols, or higher polyhydric alcohols.

In certain embodiments, a provided polymerization initiator comprises a dihydric alcohol. In certain embodiments, a provided dihydric alcohol comprises a C₂₋₄₀ diol. In certain embodiments, the dihydric alcohol is selected from the group consisting of: 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these.

In certain embodiments, where a provided polymerization initiator is a dihydric alcohol, the dihydric alcohol is selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycols) such as those having number average molecular weights of from 234 to about 2000 g/mol.

In certain embodiments, where a provided polymerization initiator is a dihydric alcohol, the dihydric alcohol comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments, where a provided polymerization initiator is a dihydric alcohol, the dihydric alcohol comprises a polymeric diol. In certain embodiments, a polymeric diol is selected from the group consisting of polyethers, polyesters, hydroxy-terminated polyolefins, polyether-copolyesters, polyether polycarbonates, polycarbonate-copolyesters, polyoxymethylene polymers, and alkoxylated analogs of any of these. In certain embodiments, the polymeric diol has an average molecular weight less than about 2000 g/mol.

In certain embodiments, a provided polymerization initiator comprises an alcohol having a formula:

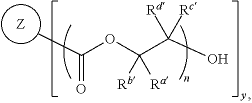

where each of R^{a′}, R^{b′}, R^{c′}, and R^{d′} is as defined above and in the classes and subclasses therein,
[symbol] comprises a multivalent moiety,
n is an integer from 2 to about 100, and
y is an integer from 2 to about 10.

In certain embodiments, provided polymerization initiators comprise polymeric materials such as hydroxyl-terminated polyolefins, polyethers, polyesters or polycarbonates.

In certain embodiments, a provided polymerization initiator comprises polypropiolactone. In certain embodiments, a provided polymerization initiator comprises an oligomer of 3-hydroxypropionic acid. In certain embodiments, a provided polymerization initiator comprises poly-3-hydroxybutyrate. In certain embodiments, a provided polymerization initiator comprises an oligomer of 3-hydroxybutanoic acid.

I(b)-2 Carboxylic Acids as Polymerization Initiators

In certain embodiments, a provided polymerization initiator comprises a —CO₂H functional group. In certain embodiments, a provided polymerization initiator comprises a C₁₋₂₀ carboxylic acid. In certain embodiments, a provided polymerization initiator comprises a C₁₋₁₂ carboxylic acid. In certain embodiments, a provided polymerization initiator comprises a C₁₋₈ carboxylic acid. In certain embodiments, a provided polymerization initiator comprises a C₁₋₆ carboxylic acid. In certain embodiments, a provided polymerization initiator is selected from the group consisting of: formic acid, acetic acid, propionic acid, butyric acid, isobutyric acid, valeric acid, 2-methylbutanoic acid, isovaleric acid, pivalic acid, hexanoic acid, 2-methyl pentanoic acid, 3-methyl pentanoic acid, hexanoic acid, acrylic acid, crotonic acid, methacrylic acid, 2-methyl butenoic acid, benzoic acid, phenylacetic acid, trifluoroacetic acid, trichloroacetic acid, and pentafluoropropionic acid. In certain embodiments, a provided polymerization initiator comprises acetic acid. In certain embodiments, a provided polymerization initiator comprises trifluoroacetic acid. In certain embodiments, a provided polymerization initiator comprises acrylic acid.

In certain embodiments, a provided polymerization initiator comprises a polycarboxylic acid. In certain embodiments, a provided polymerization initiator comprises a dicarboxylic acid, a tricarboxylic acid, or a higher carboxylic acid. In certain embodiments, a provided polymerization initiator comprises a polymeric material having a plurality of carboxylic acid groups.

In certain embodiments, a provided polymerization initiator includes a compound selected from the group consisting of:

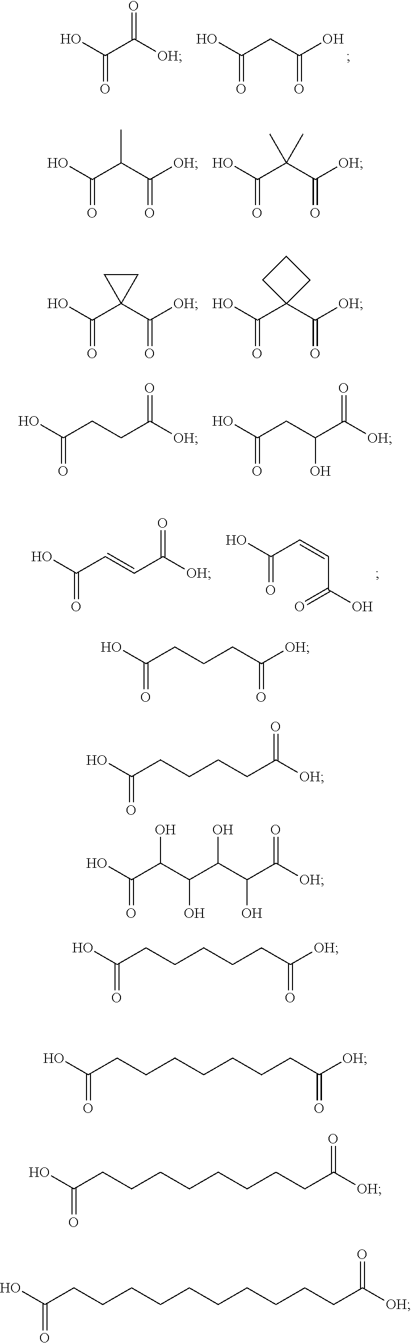

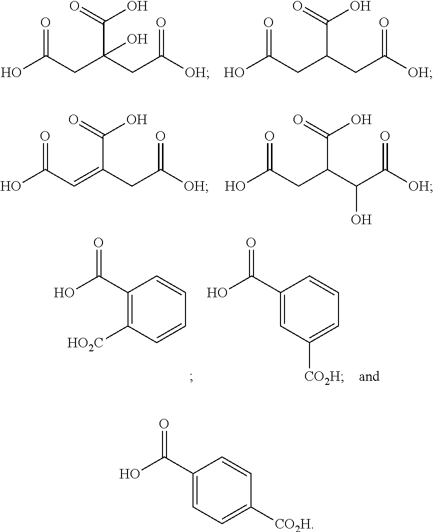

In certain embodiments, diacid provided polymerization initiators include carboxy terminated polyolefin polymers. In certain embodiments, carboxy terminated polyolefins include materials such as NISSO-PB C-series resins produced by Nippon Soda Co. Ltd.

In certain embodiments, a provided polymerization initiator is a hydroxy acid. In certain embodiments, a hydroxy acid is selected from the group consisting of:

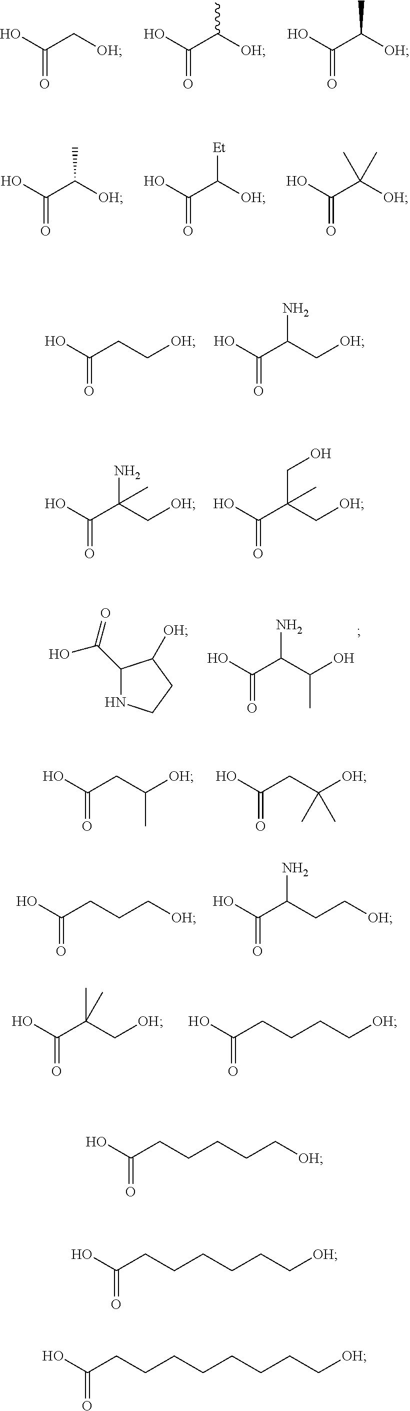

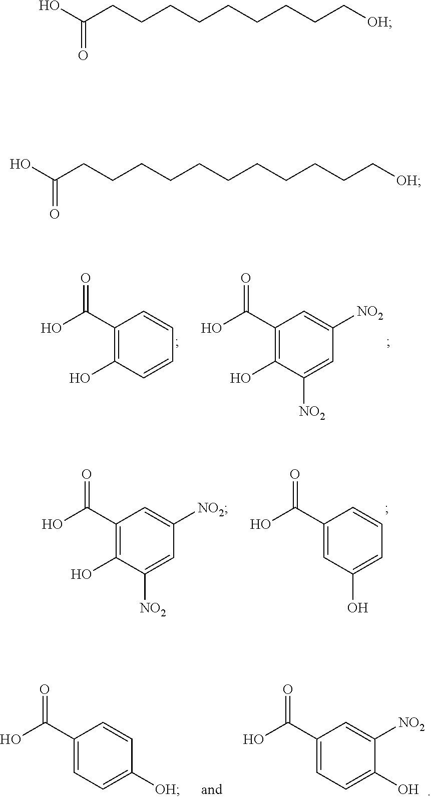

In certain embodiments, polymerization systems of the present invention are characterized in that the system includes a molar ratio of P_{In} to metal carbonyl that is greater than 10:1 in combination with a molar ratio of epoxide to P_{In} that is greater than 5:1. In certain embodiments, the molar ratio of P_{In} to metal carbonyl is greater than 10:1 and the molar ratio of epoxide to P_{In} is greater than 10:1. In certain embodiments, the molar ratio of P_{In} to metal carbonyl is greater than 10:1 and the molar ratio of epoxide to P_{In} is greater than 20:1. In certain embodiments, the molar ratio of P_{In} to metal carbonyl is greater than 20:1 and the molar ratio of epoxide to P_{In} is greater than 10:1. In certain embodiments, the molar ratio of P_{In} to metal carbonyl is greater than 50:1 and the molar ratio of epoxide to P_{In} is greater than 10:1. In certain embodiments, the molar ratio of P_{In} to metal carbonyl is greater than 100:1 and the molar ratio of epoxide to P_{In} is greater than 5:1. When P_{In} comprises more than one species, it is the total of P_{In} species that is considered in the ratio. Similarly, when the metal carbonyl comprises more than one species, it is the total of metal carbonyl species that is considered in the ratio. Similarly, when the epoxide comprises more than one species, it is the total of epoxide species that is considered in the ratio.

In certain embodiments, polymerization systems of the present invention are characterized in that the system includes a molar ratio of P_{In} to metal carbonyl that is between 10:1 and 100:1 in combination with a molar ratio of epoxide to P_{In} that is between 5:1 and 50:1. In certain embodiments, the molar ratio of P_{In} to metal carbonyl is between 10:1 and 100:1, and the molar ratio of epoxide to P_{In} is between 10:1 and 100:1. In certain embodiments, the molar ratio of P_{In} to metal carbonyl is between 10:1 and 100:1, and the molar ratio of epoxide to P_{In} is between 20:1 and 200:1. In certain embodiments, the molar ratio of P_{In} to metal carbonyl is between 20:1 and 200:1, and the molar ratio of epoxide to P_{In} is between 10:1 and 100:1. In certain embodiments, the molar ratio of P_{In} to metal carbonyl is between 50:1 and 500:1, and the molar ratio of epoxide to P_{In} is between 10:1 and 100:1. In certain embodiments, the molar ratio of P_{In} to metal carbonyl is between 100:1 and 1000:1, and the molar ratio of epoxide to P_{In} is between 5:1 and 50:1. When P_{In} comprises more than one species, it is the total of P_{In} species that is considered in the ratio. Similarly, when the metal carbonyl comprises more than one species, it is the total of metal carbonyl species that is considered in the ratio. Similarly, when the epoxide comprises more than one species, it is the total of epoxide species that is considered in the ratio.

I(c) Other Components of the Polymerization Systems

In certain embodiments, polymerization systems of the present invention comprise one or more additional components. In certain embodiments, polymerization systems of the present invention comprise Lewis acids. Suitable Lewis acids include, but are not limited to: transition metal complexes, metal salts, boron compounds, and the like. In certain embodiments, polymerization systems of the present invention comprise transesterification catalysts. Suitable transesterification catalysts include amine compounds such as DMAP, DBU, MeTBD, DABCO, imidazole derivatives and tin compounds such as dibutyl tin alkaonates, and the like.

I(c)-1 Transesterification Catalysts

In certain embodiments, polymerization systems of the present invention comprise compounds capable of promoting or catalyzing transesterification reactions. In this context, transesterification can include the participation of an acyl metal species such as those described above in the section discussing metal carbonyl chemistry. Therefore, in certain embodiments, polymerization systems of the present invention include one or more compounds capable of promoting the reaction of a hydroxyl group (which may be part of a polymerization initiator, or a chain end of a polymer or oligomer formed in the reaction mixture) with an acyl metal carbonyl compound. In certain embodiments, such a reaction may conform to the scheme below:

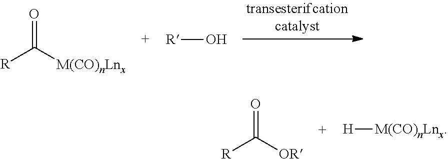

In certain embodiments, provided transesterification catalysts comprise amine compounds. In certain embodiments, provided transesterification catalysts comprise amidines, or guanidines. In certain embodiments, provided transesterification catalysts include known catalysts such as DMAP, DBU, TBD, MeTBD, DABCO, imidazole derivatives, tin compounds such as dibutyl tin alkaonates, bismuth compounds and the like.

I(c)-2 Lewis Acids

In certain embodiments, where polymerization systems of the present invention include a Lewis acid, the included Lewis acid comprises a metal complex. In certain embodiments, an included Lewis acid comprises a boron compound.

In certain embodiments, where an included Lewis acid comprises a boron compound, the boron compound comprises a trialkyl boron compound or a triaryl boron compound. In certain embodiments, an included boron compound comprises one or more boron-halogen bonds. In certain embodiments, where an included boron compound comprises one or more boron-halogen bonds, the compound is a dialkyl halo boron compound (e.g. R₂BX), a dihalo monoalkly compound (e.g. RBX₂), an aryl halo boron compound (e.g. Ar₂BX or ArBX₂), or a trihalo boron compound (e.g. BCl₃ or BBr₃).

In certain embodiments, where the included Lewis acidic comprises a metal complex, the metal complex is cationic. In certain embodiments, an included cationic metal complex has its charge balanced either in part, or wholly by one or more anionic metal carbonyl moieties. Suitable anionic metal carbonyl compounds include those described above. In certain embodiments, there are 1 to 17 such anionic metal carbonyls balancing the charge of the metal complex. In certain embodiments, there are 1 to 9 such anionic metal carbonyls balancing the charge of the metal complex. In certain embodiments, there are 1 to 5 such anionic metal carbonyls balancing the charge of the metal complex. In certain embodiments, there are 1 to 3 such anionic metal carbonyls balancing the charge of the metal complex.

In certain embodiments, where polymerization systems of the present invention include a cationic metal complex, the metal complex has the formula [(L^{c})M_{b}]^{z+}, where:
L^{c} is a ligand where, when two or more L^{c} are present, each may be the same or different;
M is a metal atom where, when two M are present, each may be the same or different;
v is an integer from 1 to 4 inclusive;
b is an integer from 1 to 2 inclusive; and
z is an integer greater than 0 that represents the cationic charge on the metal complex.

In certain embodiments, provided Lewis acids conform to structure I:

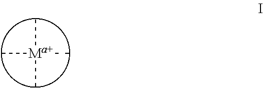

wherein:

[symbol] is a multidentate ligand;

M is a metal atom coordinated to the multidentate ligand;

a is the charge of the metal atom and ranges from 0 to 2; and

In certain embodiments, provided metal complexes conform to structure II:

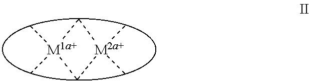

Where
a is as defined above (each a may be the same or different), and
M¹ is a first metal atom;
M² is a second metal atom;
[symbol] comprises a multidentate ligand system capable of coordinating both metal atoms.

For sake of clarity, and to avoid confusion between the net and total charge of the metal atoms in complexes I and II and other structures herein, the charge (a⁺) shown on the metal atom in complexes I and II above represents the net charge on the metal atom after it has satisfied any anionic sites of the multidentate ligand. For example, if a metal atom in a complex of formula I were Cr(III), and the ligand were porphyrin (a tetradentate ligand with a charge of −2), then the chromium atom would have a net change of +1, and a would be 1.

Suitable multidentate ligands include, but are not limited to: porphyrin derivatives 1, salen derivatives 2, dibenzotetramethyltetraaza[14]annulene (tmtaa) derivatives 3, phthalocyaninate derivatives 4, derivatives of the Trost ligand 5, tetraphenylporphyrin derivatives 6, and corrole derivatives 7. In certain embodiments, the multidentate ligand is a salen derivative. In other embodiments, the multidentate ligand is a porphyrin derivative. In other embodiments, the multidentate ligand is a tetraphenylporphyrin derivative. In other embodiments, the multidentate ligand is a corrole derivative.

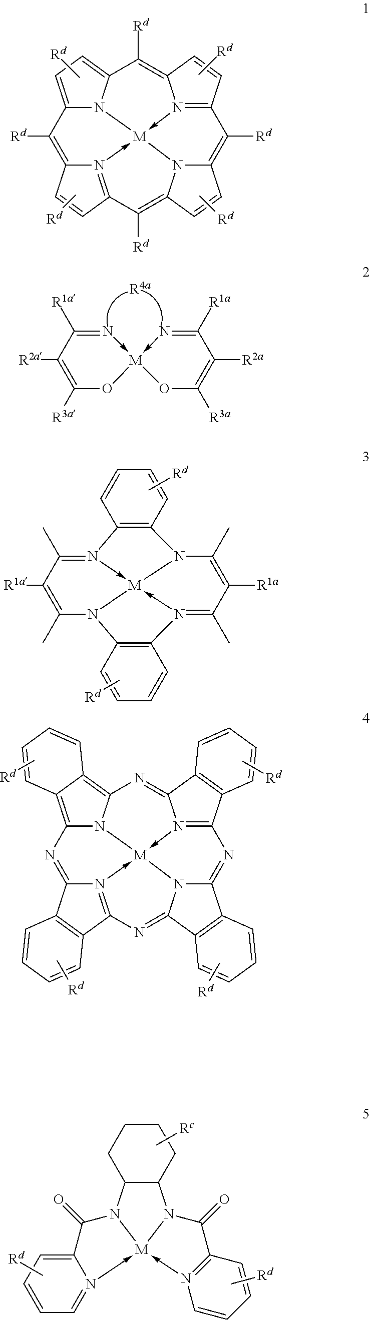

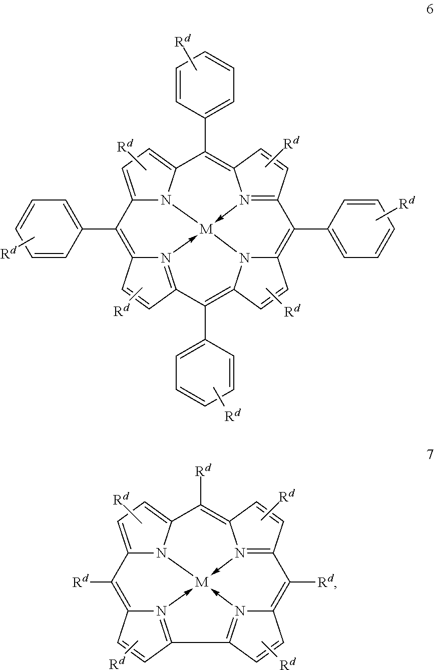

where each of R^{c}, R^{d}, R^{a}, R^{1a}, R^{2a}, R^{3a}, R^{1a′}, R^{2a′}, R^{3a′}, and M, is as defined and described in the classes and subclasses herein.

In certain embodiments, Lewis acids provided in polymerization systems of the present invention comprise metal-porphinato complexes. In certain embodiments, the moiety [symbol] has the structure:

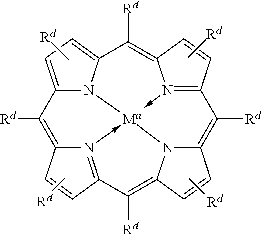

where each of M and a is as defined above and described in the classes and subclasses herein, and
R^{d} at each occurrence is independently hydrogen, halogen, —OR⁴, —NR^{y}₂, —SR, —CN, —NO₂, —SO₂R^{y}, —SOR^{y}, —SO₂NR^{y}₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-2 heteroatoms independently selected from the group consisting of nitrogen, oxygen, and sulfur, where two or more R^{d} groups may be taken together to form one or more optionally substituted rings, where each R^{y} is independently hydrogen, an optionally substituted group selected the group consisting of acyl; carbamoyl, arylalkyl; 6- to 10-membered aryl; C₁₋₁₂ aliphatic; C₁₋₁₂ heteroaliphatic having 1-2 heteroatoms independently selected from the group consisting of nitrogen, oxygen, and sulfur; 5- to 10-membered heteroaryl having 1-4 heteroatoms independently selected from the group consisting of nitrogen, oxygen, and sulfur; 4- to 7-membered heterocyclic having 1-2 heteroatoms independently selected from the group consisting of nitrogen, oxygen, and sulfur; an oxygen protecting group; and a nitrogen protecting group; two R^{y} on the same nitrogen atom are taken with the nitrogen atom to form an optionally substituted 4- to 7-membered heterocyclic ring having 0-2 additional heteroatoms independently selected from the group consisting of nitrogen, oxygen, and sulfur; and each R⁴ independently is a hydroxyl protecting group or R^{y}.

In certain embodiments, the moiety [symbol] has the structure:

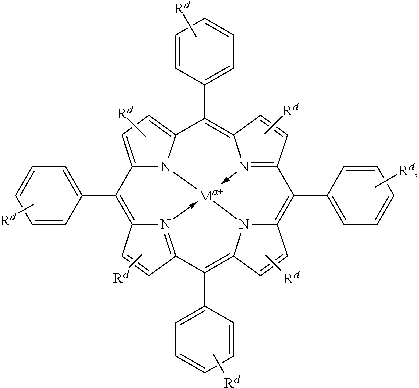

where M, a and R^{d} are as defined above and in the classes and subclasses herein.

In certain embodiments, the moiety [symbol] has the structure:

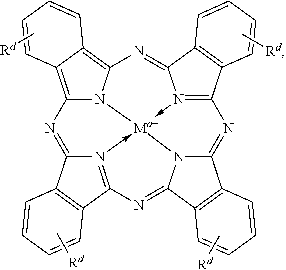

where M, a and R^{d} are as defined above and in the classes and subclasses herein.

In certain embodiments, Lewis acids included in polymerization systems of the present invention comprise metallo salenate complexes. In certain embodiments, the moiety [symbol] has the structure:

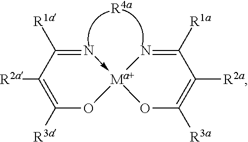

wherein:
M, and a are as defined above and in the classes and subclasses herein.
R^{1a}, R^{1a′}, R^{2a}, R^{2a′}, R^{3a}, and R^{3a′} are independently hydrogen, halogen, —OR⁴, —NR^{y}₂, —SR, —CN, —NO₂, —SO₂R^{y}, —SOR, —SO₂NR^{y}₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-2 heteroatoms independently selected from the group consisting of nitrogen, oxygen, and sulfur; wherein each R, R⁴, and R^{y} is independently as defined above and described in classes and subclasses herein,
wherein any of (R^{2a′} and R^{3a′}), (R^{2a} and R^{3a}), (R^{1a} and R^{2a}), and (R^{1a′} and R^{2a′}) may optionally be taken together with the carbon atoms to which they are attached to form one or more rings which may in turn be substituted with one or more R groups; and
R^{4a} is selected from the group consisting of:

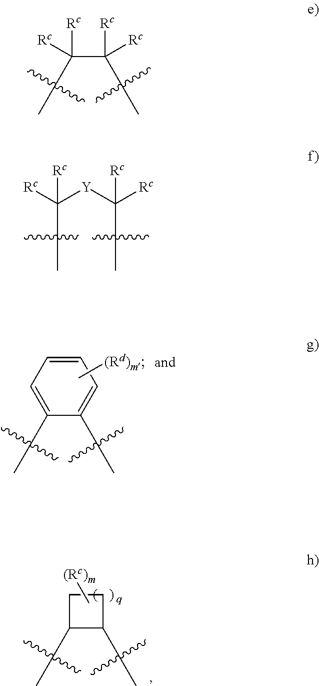

where
R^{c} at each occurrence is independently hydrogen, halogen, —OR, —NR^{y}₂, —SR^{y}, —CN, —NO₂, —SO₂R^{y}, —SOR^{y}, —SO₂NR^{y}₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-2 heteroatoms independently selected from the group consisting of nitrogen, oxygen, and sulfur;
where:
   two or more R^{c} groups may be taken together with the carbon atoms to which they are attached and any intervening atoms to form one or more rings;
   when two R^{c} groups are attached to the same carbon atom, they may be taken together along with the carbon atom to which they are attached to form a moiety selected from the group consisting of: a 3- to 8-membered spirocyclic ring, a carbonyl, an oxime, a hydrazone, an imine; and an optionally substituted alkene;
Y is a divalent linker selected from the group consisting of: —NR^{y}—, —N(R)C(O)—, —C(O)NR—, —O—, —C(O)—, —OC(O)—, —C(O)O—, —S—, —SO—, —SO₂—, —C(═S)—, —C(═NR^{y})—, —N═N—; a polyether; a C₃ to C₈ substituted or unsubstituted carbocycle; and a C₁ to C₈ substituted or unsubstituted heterocycle;
m′ is 0 or an integer from 1 to 4, inclusive;
q is 0 or an integer from 1 to 4, inclusive; and
x is 0, 1, or 2.

In certain embodiments, a provided Lewis acid comprises a metallo salen compound, as shown in formula Ia:

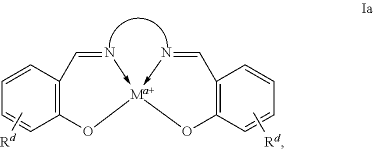

wherein each of M, R^{d}, and a, is as defined above and in the classes and subclasses herein,
[symbol] represents is an optionally substituted moiety linking the two nitrogen atoms of the diamine portion of the salen ligand, where [symbol] is selected from the group consisting of a C₃-C₁₄ carbocycle, a C₆-C₁₀ aryl group, a C₃-C₁₄ heterocycle, and a C₅-C₁₀ heteroaryl group; or an optionally substituted C₂₋₂₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—.

In certain embodiments metal complexes having formula Ia above, at least one of the phenyl rings comprising the salicylaldehyde-derived portion of the metal complex is independently selected from the group consisting of:

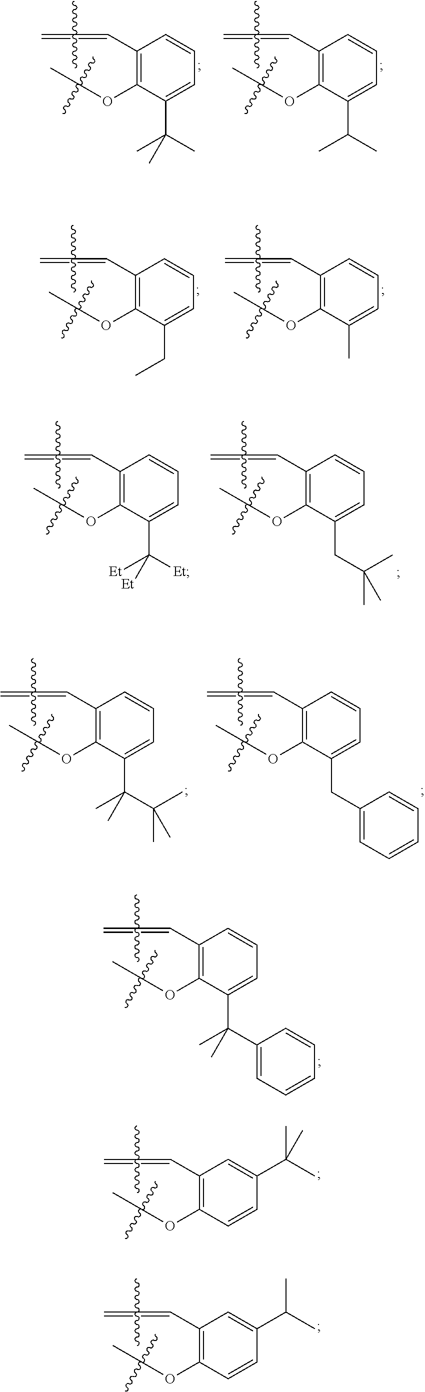

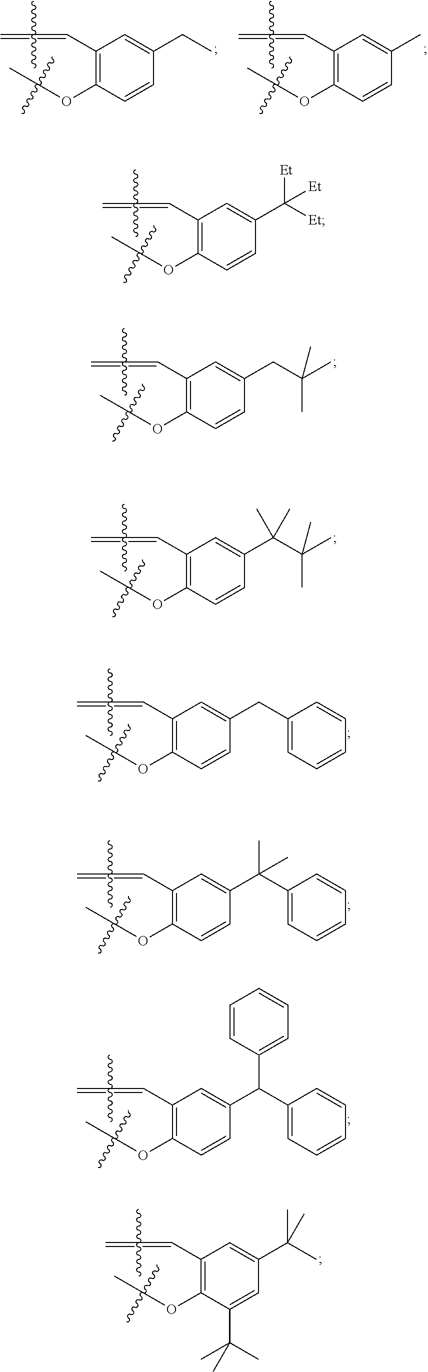

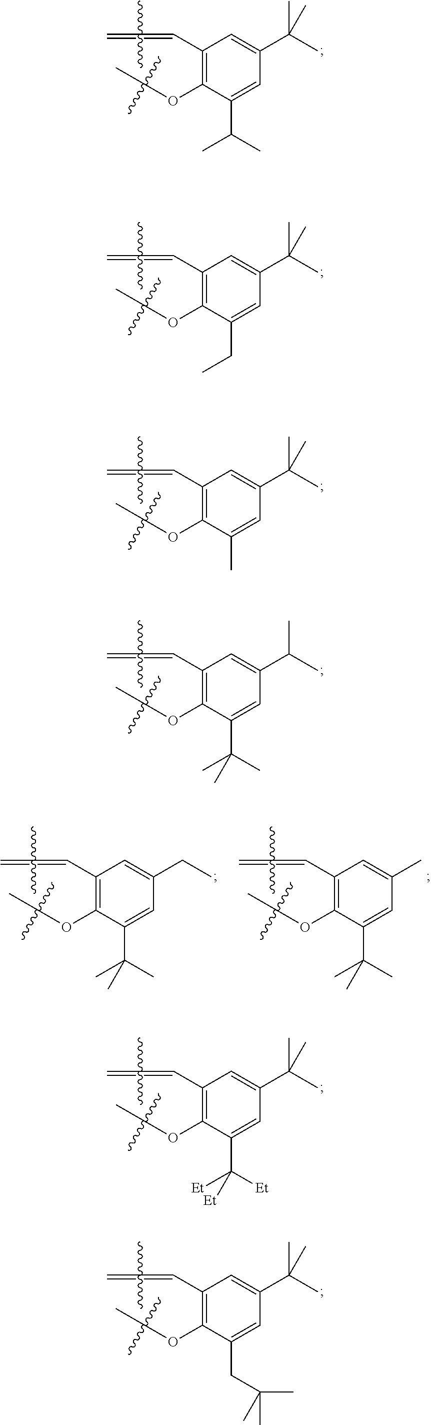

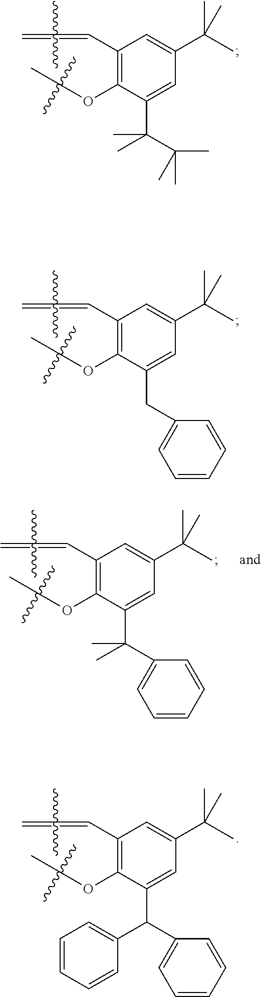

In certain embodiments, a provided Lewis acid comprises a metallo salen compound, conforming to one of formulae Va or Vb:

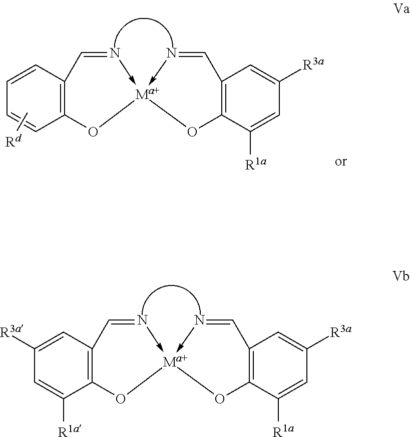

where M, a, R^{d}, R^{1a}, R^{3a}, R^{1a′}, R^{3a′}, and [symbol] , are as defined above and in the classes and subclasses herein.

In certain embodiments of metal complexes having formulae Va or Vb, each R^{1′} and R^{3′} is, independently, optionally substituted C₁-C₂₀ aliphatic.

In certain embodiments, the moiety [symbol] comprises an optionally substituted 1,2-phenyl moiety.

In certain embodiments, Lewis acids included in polymerization systems of the present invention comprise metal-tmtaa complexes. In certain embodiments, the moiety [symbol] has the structure:

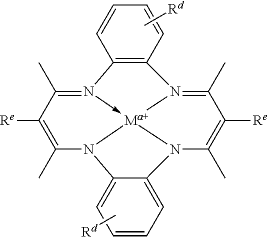

where M, a and R^{d} are as defined above and in the classes and subclasses herein, and
R^{e} at each occurrence is independently hydrogen, halogen, —OR, —NR₂, —SR, —CN, —NO₂, —SO₂R, —SOR, —SO₂NR₂; —CNO, —NRSO₂R, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-2 heteroatoms independently selected from the group consisting of nitrogen, oxygen, and sulfur.

In certain embodiments, the moiety [symbol] has the structure:

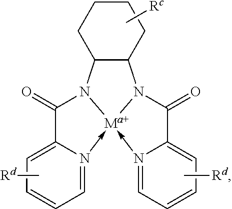

where each of M, a, R^{c} and R^{d} is as defined above and in the classes and subclasses herein.

In certain embodiments, where polymerization systems of the present invention include a Lewis acidic metal complex, the metal atom is selected from the periodic table groups 2-13, inclusive. In certain embodiments, M is a transition metal selected from the periodic table groups 4, 6, 11, 12 and 13. In certain embodiments, M is aluminum, chromium, titanium, indium, gallium, zinc cobalt, or copper. In certain embodiments, M is aluminum. In other embodiments, M is chromium.

In certain embodiments, M has an oxidation state of +2. In certain embodiments, M is Zn(II), Cu(II), Mn(II), Co(II), Ru(II), Fe(II), Co(II), Rh(II), Ni(II), Pd(II) or Mg(II). In certain embodiments M is Zn(II). In certain embodiments M is Cu(II).

In certain embodiments, M has an oxidation state of +3. In certain embodiments, M is Al(III), Cr(III), Fe(III), Co(III), Ti(III) In(III), Ga(III) or Mn(III). In certain embodiments M is Al(III). In certain embodiments M is Cr(III).

In certain embodiments, M has an oxidation state of +4. In certain embodiments, M is Ti(IV) or Cr(IV).

In certain embodiments, M¹ and M² are each independently a metal atom selected from the periodic table groups 2-13, inclusive. In certain embodiments, M is a transition metal selected from the periodic table groups 4, 6, 11, 12 and 13. In certain embodiments, M is aluminum, chromium, titanium, indium, gallium, zinc cobalt, or copper. In certain embodiments, M is aluminum. In other embodiments, M is chromium. In certain embodiments, M¹ and M² are the same. In certain embodiments, M¹ and M² are the same metal, but have different oxidation states. In certain embodiments, M¹ and M² are different metals.

In certain embodiments, one or more of M¹ and M² has an oxidation state of +2. In certain embodiments, M¹ is Zn(II), Cu(II), Mn(II), Co(II), Ru(II), Fe(II), Co(II), Rh(II), Ni(II), Pd(II) or Mg(II). In certain embodiments M¹ is Zn(II). In certain embodiments M¹ is Cu(II). In certain embodiments, M² is Zn(II), Cu(II), Mn(II), Co(II), Ru(II), Fe(II), Co(II), Rh(II), Ni(II), Pd(II) or Mg(II). In certain embodiments M² is Zn(II). In certain embodiments M² is Cu(II).

In certain embodiments, one or more of M¹ and M² has an oxidation state of +3. In certain embodiments, M¹ is A1(III), Cr(III), Fe(III), Co(III), Ti(III) In(III), Ga(III) or Mn(III). In certain embodiments M¹ is Al(III). In certain embodiments M¹ is Cr(III). In certain embodiments, M² is Al(III), Cr(III), Fe(III), Co(III), Ti(III) In(III), Ga(III) or Mn(III). In certain embodiments M² is Al(III). In certain embodiments M² is Cr(III).

In certain embodiments, one or more of M¹ and M² has an oxidation state of +4. In certain embodiments, M¹ is Ti(IV) or Cr(IV). In certain embodiments, M² is Ti(IV) or Cr(IV).

In certain embodiments, one or more neutral two electron donors coordinate to M M¹ or M² and fill the coordination valence of the metal atom. In certain embodiments, the neutral two electron donor is a solvent molecule. In certain embodiments, the neutral two electron donor is an ether. In certain embodiments, the neutral two electron donor is tetrahydrofuran, diethyl ether, acetonitrile, carbon disulfide, or pyridine. In certain embodiments, the neutral two electron donor is tetrahydrofuran. In certain embodiments, the neutral two electron donor is an epoxide. In certain embodiments, the neutral two electron donor is an ester or a lactone.

Epoxides

Any epoxide may be used in the above-described polymerization systems. In practical terms, there is likely more value in use of epoxides that are available in large quantities at relatively low cost.

In certain embodiments, a provided epoxide has a formula:

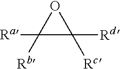

wherein:
R^{a′} is hydrogen or an optionally substituted group selected from the group consisting of C₁₋₃₀ aliphatic; C₁₋₃₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-3 heteroatoms independently selected from the group consisting of nitrogen, oxygen, and sulfur;
each of R^{b′}, R^{c′}, and R^{d′} is independently hydrogen or an optionally substituted group selected from the group consisting of C₁₋₁₂ aliphatic; C₁₋₁₂ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, and sulfur; and 4- to 7-membered heterocyclic having 1-3 heteroatoms independently selected from the group consisting of nitrogen, oxygen, and sulfur;
wherein any of (R^{b′} and R^{c′}), (R^{c′} and R^{d′}), and (R^{a′} and R^{b′}) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl.

In certain embodiments, a provided epoxide is selected from the group consisting of: ethylene oxide, propylene oxide, 1,2 butylene oxide, 2,3 butylene oxide, epoxides of higher alpha olefins, epichlorohydrin, glycidyl ethers, cyclohexene oxide, cyclopentene oxide, 3-vinyl cyclohexene oxide, 3-ethyl cyclohexene oxide, and diepoxides.

In certain embodiments, a provided epoxide may comprise a mixture of any two or more of the above. (Thus, when a provided epoxide “comprises”, e.g., ethylene oxide, it is understood that the provided epoxide can be ethylene oxide, or ethylene oxide in combination with one or more epoxides.) In certain embodiments, the provided epoxide is ethylene oxide.

In certain embodiments, the provided epoxide is propylene oxide. In certain embodiments, the provided propylene oxide is enantioenriched.

### II. Methods

In another aspect, the present invention provides methods of producing a polyester product from epoxides and CO using the polymerization systems described hereinabove. In certain embodiments, methods of the present invention comprise the step of contacting ethylene oxide with carbon monoxide in any of the polymerization systems hereinabove or described in the classes, subclasses herein.

In certain embodiments, methods of the present invention comprise the steps of:
a) providing an epoxide;
b) contacting the epoxide with carbon monoxide in the presence of metal carbonyl compound and a polymerization initiator wherein the epoxide is provided in a molar excess relative to the polymerization initiator, and the polymerization initiator is provided in a molar excess relative to the metal carbonyl compound; and
c) producing a polyester product comprising a polymer of formula

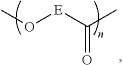

where E is an optionally substituted ethylene unit derived from the epoxide and n is an integer between about 5 and 5,000.

In certain embodiments, the yield of polyester product (based on epoxide consumed) is at least 10%. In certain embodiments, the yield of polyester product is at least 15%. In certain embodiments, the yield of polyester product is at least 20%. In certain embodiments, the yield of polyester product is at least 25%. In certain embodiments, the yield of polyester product is at least 30%. In certain embodiments, the yield of polyester product is at least 35%. In certain embodiments, the yield of polyester product is at least 40%. In certain embodiments, the yield of polyester product is at least 45%. In certain embodiments, the yield of polyester product is at least 50%. In certain embodiments, the yield of polyester product is at least 55%. In certain embodiments, the yield of polyester product is at least 60%. In certain embodiments, the yield of polyester product is at least 65%. In certain embodiments, the yield of polyester product is at least 70%. In certain embodiments, the yield of polyester product is at least 75%. In certain embodiments, the yield of polyester product is at least 80%. In certain embodiments, the yield of polyester product is at least 85%. In certain embodiments, the yield of polyester product is at least 90%.

In certain embodiments, the method includes a step after step (c) of isolating the polyester product. In certain embodiments, the method includes a step after step (c) of separating at least a portion of the catalyst from the polyester product. In certain embodiments, the method includes a step after step (c) of separating at least a portion of the catalyst from the polyester product and using the separated catalyst to perform step (b).

In certain embodiments, the epoxide provided in step (a) is ethylene oxide.

In certain embodiments, the metal carbonyl compound present in step (b) comprises a cobalt carbonyl compound.

In certain embodiments, the polymerization initiator present in step (b) comprises an alcohol.

In certain embodiments, the molar ratio of the provided epoxide to the polymerization initiator present is greater than 5:1, greater than 10:1, greater than 20:1, or greater than 50:1. In certain embodiments, the molar ratio of the provided epoxide to the polymerization initiator present is between 5:1 and 50:1, between 10:1 and 100:1, between 20:1 and 200:1, or between 50:1 and 2000:1.

In certain embodiments, the molar ratio of the polymerization initiator to the metal carbonyl compound present in step (b) is greater than 5:1, greater than 10:1, greater than 20:1, greater than 50:1, greater than 100:1, or greater than 200:1. In certain embodiments, the molar ratio of the polymerization initiator to the metal carbonyl compound present in step (b) is between 5:1 and 50:1, between 10:1 and 100:1, between 20:1 and 200:1, between 50:1 and 500:1, between 100:1 and 1000:1, or between 200:1 and 5000:1.

In certain embodiments, methods of the present invention comprise the step of contacting propylene oxide with carbon monoxide in any of the polymerization systems hereinabove or described in the classes, subclasses herein.

The methods of the present invention can be performed utilizing various reactor formats. The reactions can take place in batch processes; continuous processes or combinations of batch and continuous processes. The methods may be performed in any suitable reactor type or can be performed in a plurality of reactors arranged serially or in parallel. The required hardware and control instrumentation to implement such batch and continuous flow reaction processes are well known in the literature.

In certain embodiments, methods of the present invention comprise the additional step of converting the polyester to a small molecule product. In certain embodiments, the small molecule product comprises acrylic acid, a substituted alpha beta unsaturated carboxylic acid, an acrylate ester, an acrylamide, or an ester or amide of an alpha beta unsaturated acid. In certain embodiments, where the provided epoxide is ethylene oxide, the method includes converting the polyester to acrylic acid. In certain embodiments, where the provided epoxide is ethylene oxide, the method includes converting the polyester to acrylate ester selected from the group consisting of butyl acrylate, 2-ethyl hexyl acrylate, methyl acrylate, and ethyl acrylate.

In certain embodiments, the step of converting the polyester to a small molecule product comprises pyrolyzing the polyester. In certain embodiments, the step of converting the polyester to a small molecule product comprises pyrolyzing the polyester and isolating an alpha beta unsaturated acid. In certain embodiments, the step of converting the polyester to a small molecule product comprises hydrolyzing the polyester. In certain embodiments, the step of converting the polyester to a small molecule product comprises hydrolyzing the polyester and isolating a hydroxy acid. In certain embodiments, the step of converting the polyester to a small molecule product comprises contacting the polyester with an alcohol. In certain embodiments, the step of converting the polyester to a small molecule product comprises contacting the polyester with an alcohol and isolating an acrylate ester. In certain embodiments, the step of converting the polyester to a small molecule product comprises contacting the polyester with an amine. In certain embodiments, the step of converting the polyester to a small molecule product comprises contacting the polyester with an amine and isolating an acrylamide.

In certain embodiments, methods of the present invention further comprise the step of (d) manufacturing a useful article from the polyester product or the small molecule product formed the polyester product. Such processing steps are well known in the art. In certain embodiments, manufacturing a useful article from the polyester product comprises making a consumer packaging item. In certain embodiments, a consumer packaging item comprises a bottle, a disposable food container, a foamed article, a blister pack or the like. In certain embodiments, the useful article comprises a film, such an agricultural film, or a packaging film. In certain embodiments, the useful article comprises a molded plastic article such as eating utensils, plastic toys, coolers, buckets, a plastic component in a consumer product such as electronics, automotive parts, sporting goods and the like. In certain embodiments a useful article comprises any of the myriad of articles presently made from thermoplastics such as polyethylene, polypropylene, polystyrene, PVC and the like. In certain embodiments, the useful article comprises a fiber or a fabric.

### EXEMPLIFICATION

### Example 1

### Polymerization Using a Lewis Acid/Cobalt Carbonyl Complex Catalyst

A tetrahydrofuran solution of [(tpp)Al][Co(CO)₄](1 molar equiv.) in a stainless steel pressure reactor is brought to 400 psi (2750 kPa) CO and 50° C. Ethylene oxide (100 molar equiv.) and ethanol (10 molar equiv.) are added to this solution and the total reaction pressure is increased to 800 psi (5500 kPa) with CO. The reaction is maintained at this pressure and temperature and the reaction is monitored. When product formation is complete, the reactor is cooled to room temperature and depressurized.

### Example 1b

This example is performed using the same procedure as Example 1, but utilizing a ratio 1000 molar equivalents of ethylene oxide and 20 molar equivalents of ethanol. This example leads to formation of beta propiolactone with a higher average molecular weight than Example 1.

### Example 1c

This example is performed using the same procedure as Example 1b, but substituting R-propylene oxide for ethylene oxide.

### Example 2

### Polymerization Using a Lewis Acid/Cobalt Carbonyl Complex and Transesterification Catalyst

A solution of [(tpp)Al][Co(CO)₄](1 molar equiv.) in tetrahydrofuran is brought up to 400 psi (2750 kPa) CO and 50° C. Ethylene oxide (100 molar equiv.), ethanol (10 molar equiv.) and 4-dimethylaminopyridine (DMAP, 1 molar equiv.) are then added to this solution and the total reaction pressure is increased to 800 psi (5500 kPa) with CO. The reaction is monitored and the reactor is cooled to room temperature and depressurized when product formation is complete.

### Example 3

This example is performed using the same procedure as Example 2, but substituting 1,5,7-triazabicyclo[4.4.0]dec-5-ene (TBD) in place of DMAP as the transesterification catalyst.

### Example 4

This example is performed using the same procedure as Example 2, but substituting 7-methyl-1,5,7-triazabicyclo[4.4.0]dec-5-ene (MTBD) in place of DMAP as the transesterification catalyst.

### Example 5

This example is performed using the same procedure as Example 2, but substituting dibutyltin(IV) dilaurate (DBTL) in place of DMAP as the transesterification catalyst.

### Example 6

### (Polymerization Using HCo(CO)₄ and a Transesterification Catalyst)

Co₂(CO)₈ (1 molar equiv.) is dissolved in 1,2-dimethoxyethane in a high pressure autoclave. To this solution, 400 psi (2750 kPa) of syngas (H₂/CO, 1/3 by mol) is added and the reactor is heated to 80° C. to generate HCo(CO)₄ in situ. Ethylene oxide (100 molar equiv.), ethanol (10 molar equiv.) and MTBD (2 molar equiv.) are then added to the solution and the total reactor pressure is increased to 800 psi (5500 kPa). The reaction is monitored and the reactor is cooled to room temperature and depressurized when product formation is complete.

### Example 7

This example is performed using the same procedure as Example 6, but using DMAP as the transesterification catalyst.

### Example 8

This example is performed using the same procedure as Example 6, but using ethylene glycol as the polymerization initiator.

### Example 9

This example is performed using the same procedure as Example 6, but using methyl-3-hydroxypropionate as the polymerization intiator.

### Example 10

This example is performed using the same procedure as Example 6, but using acetic acid as the polymerization intiator.

### Example 11

### (Polymerization Using HCo(CO)₄ Modified with an Auxiliary Ligand and a Transesterification Catalyst)

Co₂(CO)₈ (1 molar equiv.) is dissolved in tetrahydrofuran in a high pressure autoclave. To this solution, 400 psi (2750 kPa) of syngas (H₂/CO, 1/3 by mol) is added and the reactor is heated to 80° C. to generate HCo(CO)₄ in situ. A solution of triphenyl phosphine (2 molar equiv.) in tetrahydrofuran is added to make the HCo(CO)₃(PPh₃) complex in situ. Ethylene oxide (100 molar equiv.), ethanol (10 molar equiv.) and MTBD (2 molar equiv.) are then added to the solution and the total reactor pressure is increased to 800 psi (5500 kPa) and the temperature is brought to 80° C. The reaction is monitored and the reactor is cooled to room temperature and depressurized when product formation is complete.

### Example 11

This example is performed using the same procedure as Example 10, but using tributyl phosphine as the auxiliary ligand.

### Example 12

This example is performed using the same procedure as Example 10, but using tricyclohexyl phosphine as the auxiliary ligand.

### Example 13

### (Polymerization Using HRh(CO)(PPh₃)₃ and a Transesterification Catalyst)

HRh(CO)(Ph₃)₃ (1 molar equiv.) is dissolved in tetrahydrofuran in a high pressure autoclave. To this solution, 400 psi (2750 kPa) of syngas (H₂/CO, 1/3 by mol) is added and the reactor is heated to 80° C. Ethylene oxide (100 molar equiv.) and ethanol (10 molar equiv.) are then added to the solution and the total reactor pressure is increased to 800 psi (5500 kPa). The reaction is monitored and the reactor is cooled to room temperature and depressurized when product formation is complete.

### Example 14

This example is performed using the same procedure as Example 13, but using pure CO instead of syngas.

### Example 15

This example is performed using the same procedure as Example 13, but using Rh(acac)₂(CO)₂ as the carbonylation catalyst.

### Example 16

This example is performed using the same procedure as Example 13, but including 1 molar equivalent of MTBD relative to Rh.

### Other Embodiments

The foregoing has been a description of certain non-limiting embodiments of the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for the copolymerization of an epoxide and carbon monoxide comprising the steps of:
a) providing an epoxide;
b) contacting the epoxide with carbon monoxide in the presence of a metal carbonyl compound and a polymerization initiator wherein the epoxide is provided in a molar excess relative to the polymerization initiator, and the polymerization initiator is provided in a molar excess relative to the metal carbonyl compound; and
c) producing a polyester product comprising a polymer of formula 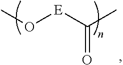
where E is an optionally substituted ethylene unit derived from the epoxide and n is an integer between about 5 and 5,000.

2. The method of claim 1, wherein the metal carbonyl compound comprises a hydrido metal carbonyl.

3. The method of claim 2, wherein the hydrido metal carbonyl comprises HCo(CO)₄.

4. The method of claim 1, wherein the polymerization initiator comprises an alcohol.

5. The method of claim 1, wherein the polymerization initiator comprises a carboxylate anion.

6. The method of claim 1, wherein the epoxide comprises ethylene oxide.

7. The method of claim 1, wherein the molar ratio of epoxide to polymerization initiator is greater than 5:1; or
wherein the molar ratio of epoxide to polymerization initiator is greater than 10:1; or
wherein the molar ratio of epoxide to polymerization initiator is greater than 20:1; or
wherein the molar ratio of epoxide to polymerization initiator is greater than 50:1.

8. The method of claim 1, wherein the molar ratio of polymerization initiator to metal carbonyl compound is greater than 5:1; or
wherein the molar ratio of polymerization initiator to metal carbonyl compound is greater than 10:1; or
wherein the molar ratio of polymerization initiator to metal carbonyl compound is greater than 20:1; or
wherein the molar ratio of polymerization initiator to metal carbonyl compound is greater than 50:1; or
wherein the molar ratio of polymerization initiator to metal carbonyl compound is greater than 100:1; or
wherein the molar ratio of polymerization initiator to metal carbonyl compound is greater than 200:1.

9. The method of claim 1, wherein the epoxide is ethylene oxide, the metal carbonyl compound is a cobalt carbonyl compound, the polymerization initiator is selected from the group consisting of: alcohols, carboxylic acids, carboxylate salts, and a combination of any two or more of these, and
wherein the molar ratio of the epoxide to the polymerization is greater than 10:1 and the molar ratio of polymerization initiator to cobalt carbonyl compound is greater than 5:1.

10. The method of claim 1, wherein a yield of polyester product (based on epoxide consumed) is at least 10%; at least 20%; at least 30%; at least 50%, at least 75%, or at least 90%.

11. The method of claim 1, further comprising converting the polyester product to a small molecule product.

12. The method of claim 11, wherein the small molecule product comprises acrylic acid, a substituted alpha beta unsaturated carboxylic acid, an acrylate ester, an acrylamide, or an ester or amide of an alpha beta unsaturated acid.

13. The method of claim 1, further comprising converting the polyester product to a consumer packaging item, a film, a molded plastic article, a plastic component of a consumer product, a fiber or a fabric.

14. A polymerization system for the copolymerization of epoxides and carbon monoxide, the system comprising: an epoxide, a metal carbonyl compound, and a polymerization initiator, characterized in that the epoxide is present in a molar excess relative to the polymerization initiator and the polymerization initiator is present in a molar excess relative to the metal carbonyl compound.

15. The polymerization system of claim 14, wherein the metal carbonyl compound comprises a hydrido metal carbonyl.

16. The polymerization system of claim 15, wherein the hydrido metal carbonyl comprises HCo(CO)₄.

17. The polymerization system of claim 14, wherein the polymerization initiator comprises an alcohol.

18. The polymerization system of claim 17, wherein the alcohol comprises a diol.

19. The polymerization system of claim 14, wherein the polymerization initiator comprises a carboxylate anion.

20. The polymerization system of claim 14, wherein the epoxide comprises ethylene oxide.

21. The polymerization system of claim 14, wherein the molar ratio of epoxide to polymerization initiator is greater than 5:1; or
wherein the molar ratio of epoxide to polymerization initiator is greater than 10:1; or
wherein the molar ratio of epoxide to polymerization initiator is greater than 20:1; or
wherein the molar ratio of epoxide to polymerization initiator is greater than 50:1.

22. The polymerization system of claim 14, wherein the molar ratio of polymerization initiator to metal carbonyl compound is greater than 5:1; or
wherein the molar ratio of polymerization initiator to metal carbonyl compound is greater than 10:1; or
wherein the molar ratio of polymerization initiator to metal carbonyl compound is greater than 20:1; or
wherein the molar ratio of polymerization initiator to metal carbonyl compound is greater than 50:1; or
wherein the molar ratio of polymerization initiator to metal carbonyl compound is greater than 100:1; or
wherein the molar ratio of polymerization initiator to metal carbonyl compound is greater than 200:1.
